(19) United States
(12) Patent Application Publication
(10) Pub. No.: US 2025/0157715 A1
(43) Pub. Date: May 15, 2025

(54) TURRET ASSEMBLY

(71) Applicant: Hitachi Energy Ltd, Zürich (CH)

(72) Inventors: Samuel BRODEUR, St-Bruno (CA); Patrice LAMOTHE, St-Antoine-sur-Richelieu (CA); Guillaume COMEAU, Saint-Basile-le-Grand (CA); Omar ZANFI, Laval (CA)

(21) Appl. No.: 18/834,927

(22) PCT Filed: Feb. 11, 2022
(86) PCT No.: PCT/EP2022/053430

§ 371 Date: Jul. 31, 2024

(51) Int. Cl. H01F 27/04

(52) U.S. Cl. CPC H01F 27/04

(57) ABSTRACT

A turret assembly comprises a turret configured to contain pressure created and including a circumferential outer surface, an elbow portion configured to couple to a housing assembly, and a distal portion extending distally from the elbow portion; and a coupling assembly configured to further couple the turret to the housing assembly, the coupling assembly including a reinforcement support configured to substantially surround and contact the circumferential outer surface of the turret.

### CROSS-REFERENCE TO RELATED APPLICATIONS

This application is a 35 U.S.C. § 371 national stage application of PCT International Application No. PCT/EP2022/053430 filed on Feb. 11, 2022, the disclosure and content of which is incorporated by reference herein in its entirety.

### TECHNICAL FIELD

The embodiments described herein are generally directed to turret assemblies for transformers or shunt reactors.

### BACKGROUND

A high-energy arc inside a turret or chimney between a high-voltage (“HV”) lead and a housing assembly or tank of a transformer or shunt reactor creates a sudden pressure rise which could result in oil leak, toxic fire, and part projections. For example, transformer major failure between the HV lead to chimney represent about 10% of the cases and 17% of the toxic fires in a 735 kV network. This event is a threat to personal safety, creates environmental concerns, and may lead to commercial loss as well.

### SUMMARY

One or more embodiments are disclosed for a turret assembly that contains pressure caused by a sudden pressure rise from a high-energy arc.

A turret assembly is disclosed that comprises a turret configured to contain pressure and including a circumferential outer surface, an elbow portion configured to couple to a housing assembly, and a distal portion extending distally from the elbow portion; and a coupling assembly configured to further couple the turret to the housing assembly, the coupling assembly including a reinforcement support configured to substantially surround and contact the circumferential outer surface of the turret.

One or more implementations or embodiments of the turret assembly include one or more of the following: the turret includes a plurality of sections and a junction where the sections come together, and the coupling assembly includes a plurality of reinforcement supports configured to substantially circumferentially surround and contact the circumferential outer surface of the turret in at least one of the elbow portion and the distal portion at locations other than the junction; the elbow portion includes an elbow horizontal portion, an elbow angle portion, and an elbow vertical portion, and the coupling assembly includes a plurality of reinforcement supports configured to substantially circumferentially surround and contact the circumferential outer surface of the turret in the distal portion and at least one of the elbow horizontal portion, the elbow angle portion, and the elbow vertical portion; the turret includes at least one shell having a thickness greater than 8 mm; the coupling assembly includes at least one of reinforcement support(s), plate(s), connection plate(s), flange(s), reinforcement(s), arm(s), connection part(s), bolt(s), pin(s), weld(s), key(s), and keyway(s); the at least one flange has a thickness greater than 30 mm; the at least one bolt has a diameter greater than m20; the at least one bolt is configured for a tightening torque application greater than 300 Nm; the coupling assembly includes a plurality of reinforcement supports that both substantially circumferentially surround and contact the circumferential outer surface of the turret in the distal portion, a distal portion plate coupled to the plurality of reinforcement supports of the distal portion, a housing assembly plate configured to be coupled to the housing assembly, and a connection plate coupling the distal portion plate to the housing assembly plate; an elbow portion plate coupled to the reinforcement support of the elbow portion and the housing assembly plate via the connection plate; an elbow reinforcement configured to structurally reinforce the elbow portion; the coupling assembly includes a plurality of reinforcement supports that both substantially circumferentially surround and contact the circumferential outer surface of the turret in the distal portion, a distal portion reinforcement coupled to the plurality of reinforcement supports of the distal portion, a housing assembly arm configured to be coupled to the housing assembly, and a turret arm coupling the distal portion reinforcement to the housing assembly arm; at least one bolt coupling the turret arm to the housing assembly arm; an elbow portion reinforcement coupled to the reinforcement support of the elbow portion, a lower housing assembly arm configured to be coupled to the housing assembly, and a lower turret arm coupling the elbow portion reinforcement to the lower housing assembly arm; a housing assembly plate configured to be coupled to the housing assembly; the coupling assembly includes a plurality of reinforcement supports that both substantially circumferentially surround and contact the circumferential outer surface of the turret in the distal portion, a distal portion connector coupled to the plurality of reinforcement supports of the distal portion, a housing assembly connector configured to be coupled to the housing assembly, and a turret arm and a plurality of connection pins coupling the distal portion connector to the housing assembly connector; an elbow portion connector coupled to the reinforcement support of the elbow portion, a housing connector configured to be coupled to the housing assembly, and a lower turret arm and a plurality of connection pins coupling the elbow portion connector to the housing assembly connector; the coupling assembly includes a plurality of reinforcement supports that both substantially circumferentially surround and contact the circumferential outer surface of the turret in the distal portion, a distal portion plate coupled to the plurality of reinforcement supports of the distal portion, a housing assembly plate configured to be coupled to the housing assembly, and a connection arm and a plurality of connection pins coupling the distal portion plate to the housing assembly plate; an elbow portion plate coupled to the reinforcement support of the elbow portion, and a lower connection arm and a plurality of connection pins coupling the elbow portion plate to the housing assembly plate; the elbow portion includes an elbow horizontal portion, an elbow angle portion, and an elbow inclined portion, the turret is inclined at an angle, and the coupling assembly includes a plurality of reinforcement supports that both substantially circumferentially surround and contact the circumferential outer surface of the turret in the distal portion and in at least one of the elbow horizontal portion, the elbow angle portion, and the elbow inclined portion; a housing assembly configured to house an electrical component, the housing assembly comprises a tank, and the electrical component comprises at least one of a transformer and a shunt reactor housed within the tank; and/or the housing assembly comprises a tank and the tank includes at least one of a tank wall reinforcements and a tank wall reinforcement gussets in an area of the tank where the turret assembly is coupled to the at least one of the plurality of outer walls.

### BRIEF DESCRIPTION OF THE DRAWINGS

The details of the present disclosure, both as to its structure and operation, may be gleaned in part by study of the accompanying drawings, in which like reference numerals refer to like parts, and in which:

FIG. 1 is simplified schematic of an embodiment of a turret assembly and housing assembly of a transformer or shunt reactor;

FIG. 2 illustrates perspective view of an additional embodiment of a turret assembly coupled to an outer wall of a housing assembly of a transformer or shunt reactor;

FIG. 3 illustrates a cross-sectional view of the turret assembly coupled to the outer wall of the housing assembly of FIG. 2;

FIG. 4 illustrates perspective view of another embodiment of a turret assembly coupled to an outer wall of a housing assembly of a transformer or shunt reactor;

FIG. 5 illustrates a cross-sectional view of the turret assembly coupled to the outer wall of the housing assembly of FIG. 4;

FIG. 6 illustrates perspective view of a further embodiment of a turret assembly coupled to an outer wall of a housing assembly of a transformer or shunt reactor;

FIG. 7 illustrates a cross-sectional view of the turret assembly coupled to the outer wall of the housing assembly of FIG. 6;

FIG. 8 illustrates an enlarged perspective view of a coupling assembly of the turret assembly of FIG. 6;

FIG. 9 illustrates perspective view of a still further embodiment of a turret assembly coupled to an outer wall of a housing assembly of a transformer or shunt reactor;

FIG. 10 illustrates a cross-sectional view of the turret assembly coupled to the outer wall of the housing assembly of FIG. 9;

FIG. 11 illustrates an enlarged perspective view of a coupling assembly of the turret assembly of FIG. 9;

FIG. 12 illustrates a front elevational view of a vertical turret assembly embodiment and inclined turret assembly embodiments coupled to an outer wall of a housing assembly of a transformer or shunt reactor;

FIG. 13 illustrates a perspective view of the vertical turret assembly embodiment of FIG. 12;

FIG. 14 illustrates a cross-sectional view of the vertical turret assembly embodiment of FIG. 13;

FIG. 15 illustrates a perspective view of one of the inclined turret assembly embodiments of FIG. 12; and

FIG. 16 illustrates a cross-sectional view of the inclined turret assembly embodiment of FIG. 15.

### DETAILED DESCRIPTION

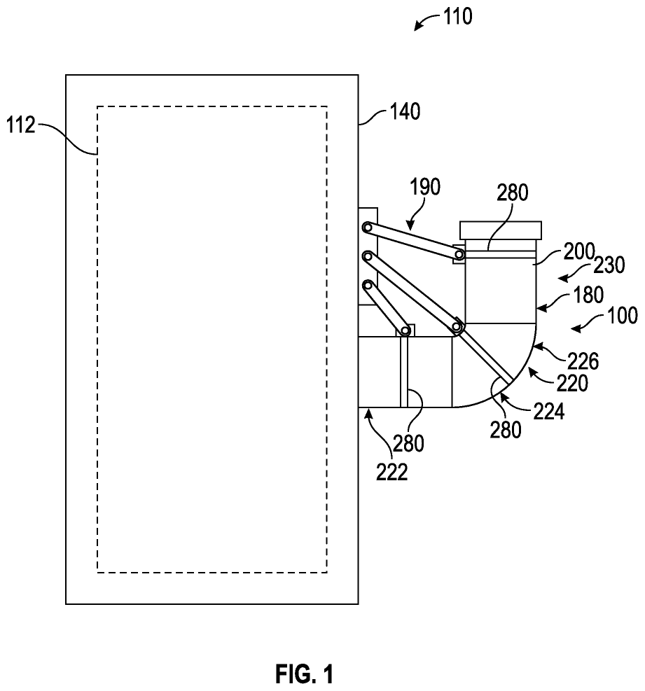

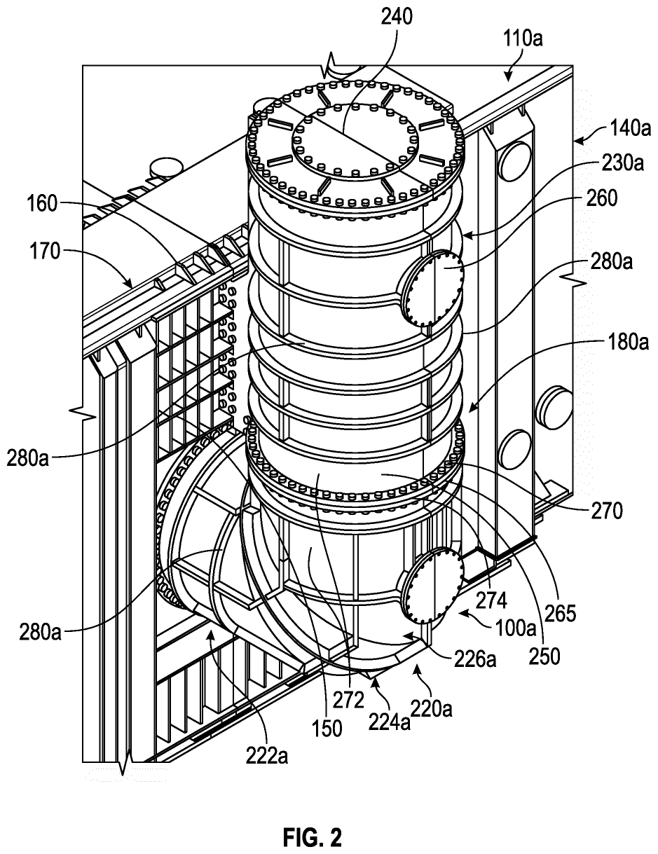

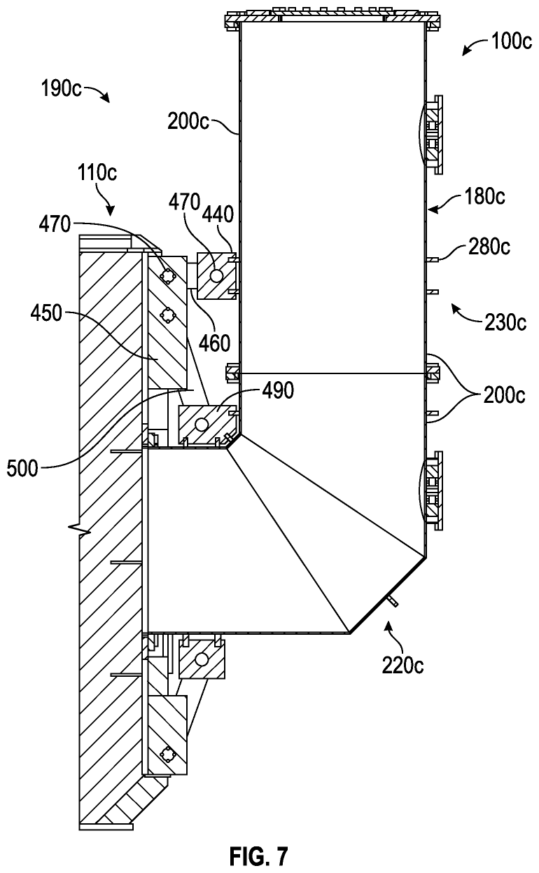

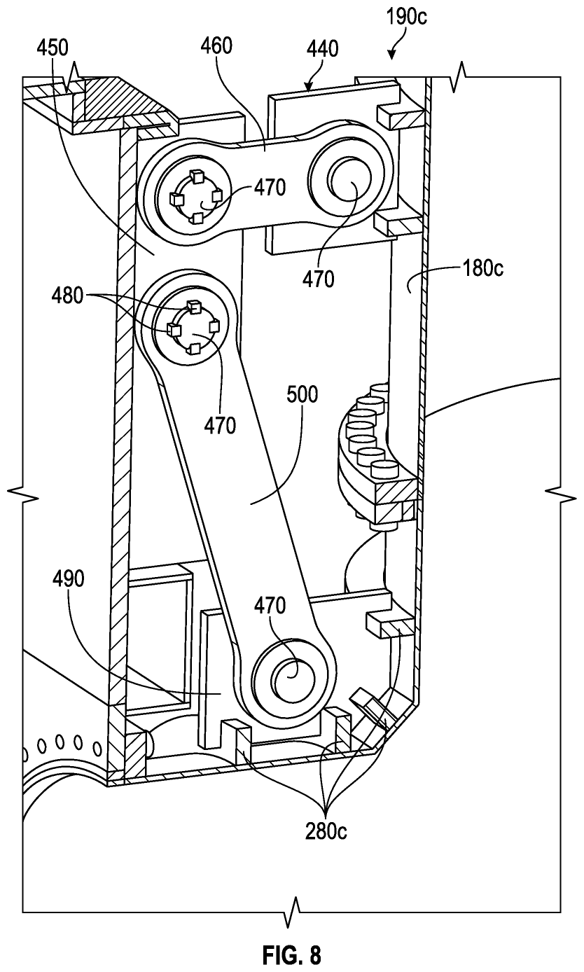

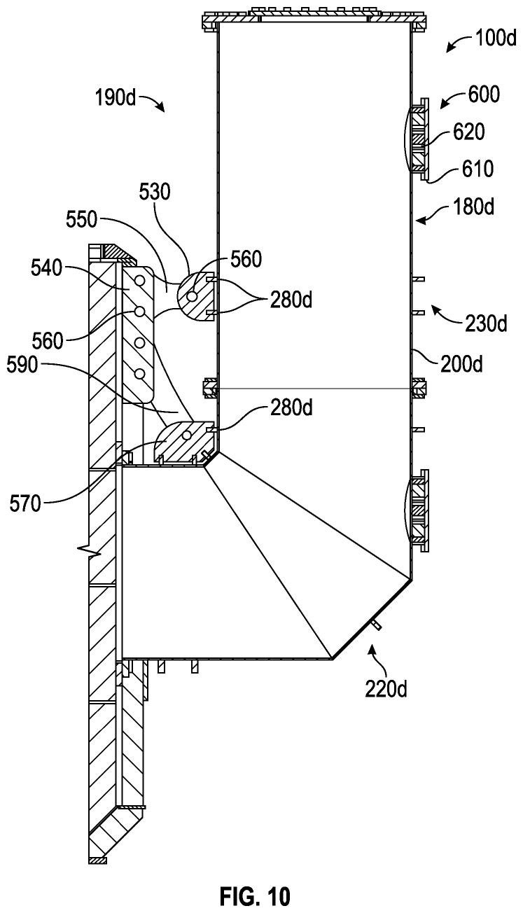

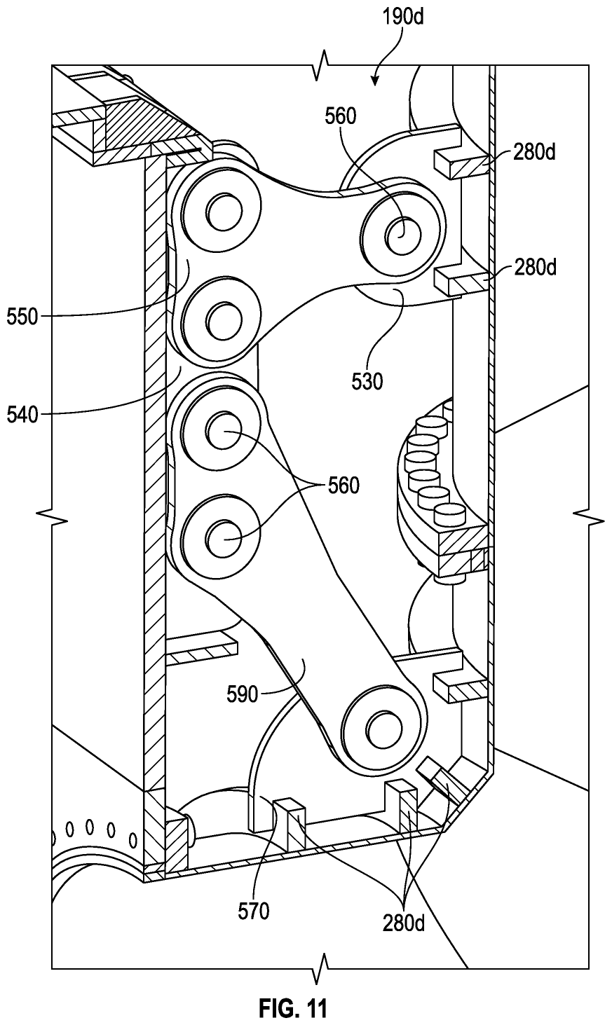

With reference to FIG. 1, an embodiment of a turret assembly 100 for a high-voltage (“HV”) lead will be described. The turret assembly 100 is coupled to housing 110, which may be, for example, but not by way of limitation, a tank. The turret assembly 100 of FIG. 1 and further embodiments of a turret assembly 100 shown and described with respect to FIGS. 2-16 will be described with respect to a housing assembly of a transformer 112. However, in alternative embodiments, the transformer 112 is replaced with a shunt reactor; the housing assembly 110 shown and described is for a shunt reactor (not shown) instead of a transformer. The turret assembly 100 is configured to contain pressure caused by a sudden pressure rise from a high-energy arc, inhibiting oil leak, toxic fire, and part projections. As shown in FIG. 1, the turret assembly 100 comprises a turret 180 configured to contain the above-described pressure and includes a circumferential outer surface 200. The turret assembly 100 further includes an elbow portion 220 having an elbow horizontal portion 222 extending laterally from the housing assembly 110, an elbow angle portion 224 extending from the elbow horizontal portion 222, and an elbow vertical portion 226 extending from the elbow angle portion 224. A distal portion 230 extends distally from the elbow portion 220.

As further shown in FIG. 1, a coupling assembly 190 couples the turret assembly 100 to one or more walls 140 of the housing assembly 110. The coupling assembly 190 includes one or more reinforcement supports 280 configured to substantially surround and contact the circumferential outer surface 200 of the turret assembly 100 in one or more of the elbow horizontal portion 222, the elbow angle portion 224, the elbow vertical portion 226, and the distal portion 230. As shown and described with respect to the further embodiments of FIGS. 2-12, the coupling assembly 190 may include, but not by way of limitation, one or more of plates, welds, bolts, arms, and connectors, to couple the reinforcement support(s) 280 to the housing assembly 110.

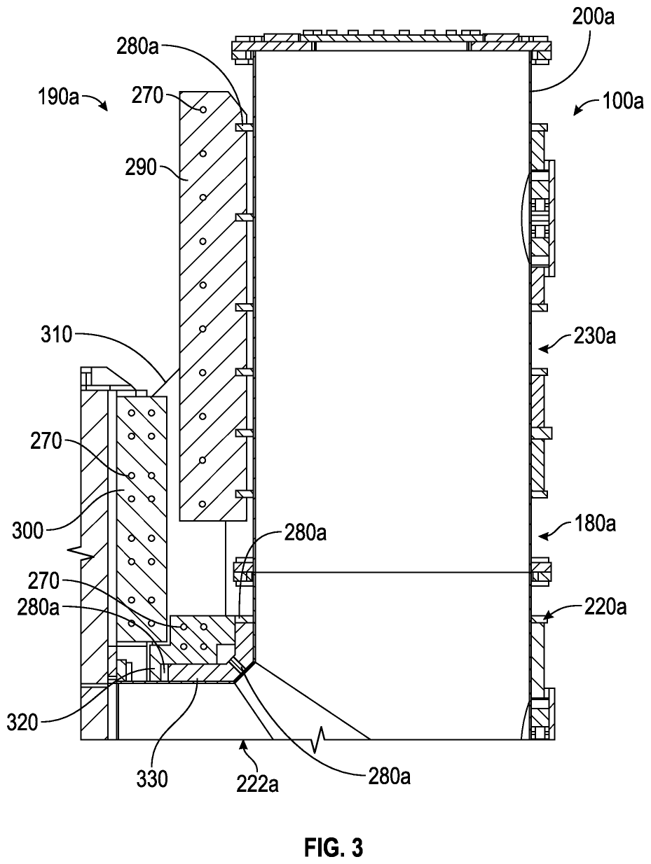

With reference to FIGS. 2 and 3, an additional embodiment of a turret assembly 100a will be described. Like elements to those shown and described herein will be identified with the same reference number, but with an “a” suffix, and the disclosure of such like elements is incorporated herein. The turret assembly 100a is coupled to transformer housing assembly 110a. The housing assembly 110a includes a plurality of outer walls 140a. Wall reinforcements 150 and wall reinforcement gussets 160 are included in an area 170 of the housing assembly 110a where the turret assembly 100a is coupled to one of the walls 140.

The turret assembly 100a includes a cylindrical turret or chimney 180a and a coupling assembly 190a that couples the turret 180a to one of the walls 140a of the housing assembly 110a. The turret 180a is cylindrical and includes a circumferential outer surface 200a. The turret 180a includes an elbow portion 220a having an elbow horizontal portion 222a extending laterally from the housing assembly 110a, an elbow angle portion 224a extending from the elbow horizontal portion 222a, and an elbow vertical portion 226a extending from the elbow angle portion 224a. A distal portion 230a extends distally from the elbow portion 220a and includes a bushing 240. To further strengthen and reinforce the turret 180a and help contain pressure caused by a sudden pressure rise from a high-energy arc, the turret 180 includes one or more shells 250 having a thickness greater than 8 mm, one or more flanges 260, 265 have a thickness greater than 30 mm, one or more bolts 270 have a diameter greater than m20, and the one or more bolts 270 configured for a tightening torque application greater than 300 Nm. The turret 180a includes a plurality of sections 272 and junction(s) 274 where the sections 272 come together.

The coupling assembly 190a includes one or more reinforcement supports 280a that substantially circumferentially surround and contact the circumferential outer surface 200a of the turret 180a in one or more of the elbow horizontal portion 222a, the elbow angle portion 224a, the elbow vertical portion 226a, and the distal portion 230a. The one or more reinforcement supports 280a are preferably one or more reinforcement rings, as shown, which circumferentially surround and contact the circumferential outer surface 200a of the turret 180a around the entire circumferential surface of the cylindrical turret 180a at locations other than the junction(s) 274 in order to uniformly strengthen the turret 180a around its circumferential outer surface 200a and smoothly distribute the stress caused by a sudden pressure rise from a high-energy arc.

One or more distal portion plates 290 are coupled to the reinforcement support(s) 280a of the distal portion 230a via a plurality of welds. One or more housing assembly plates 300 are coupled to the housing assembly 110a, such as via a plurality of welds and bolts 270. One or more connection plates 310 and a plurality of bolts 270 couple the distal portion plate 290a to the housing assembly plate 300. One or more elbow portion plates 320 couple the reinforcement support(s) 280a of the elbow portion 220a to the housing assembly plate(s) 300 via connection plate(s) 310, bolts 270, and welds. One or more elbow reinforcements 330 structurally reinforce the elbow portion 220a. Such elbow reinforcement(s) 330 may also be incorporated in the other turret assembly embodiments shown and described herein.

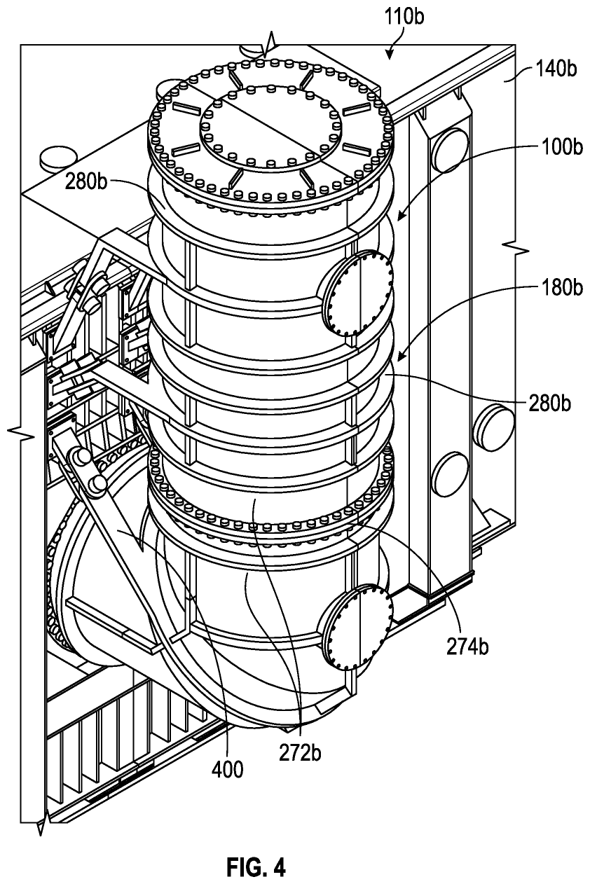

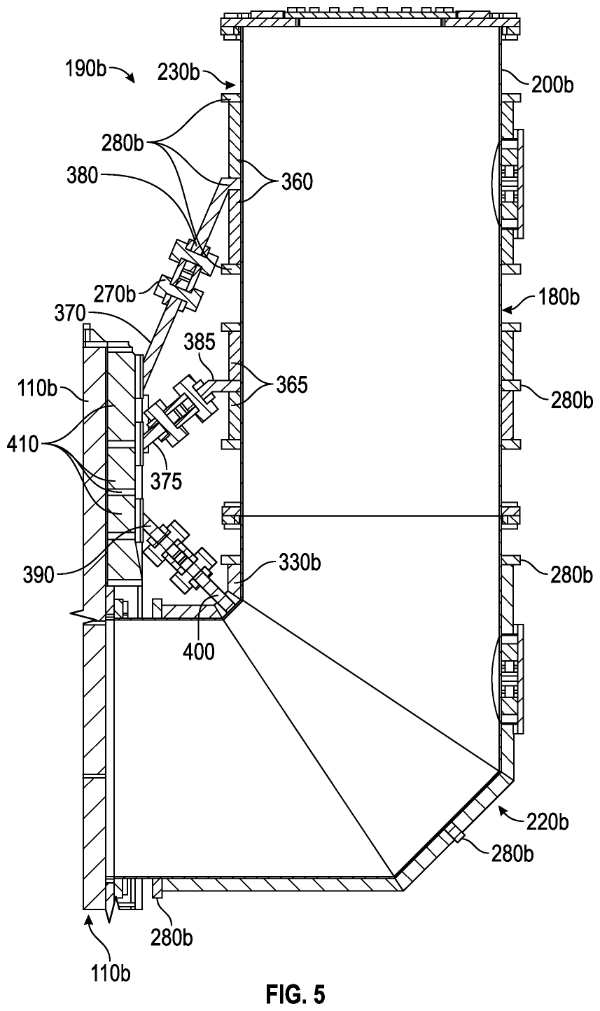

With reference to FIGS. 4 and 5, another embodiment of a turret assembly 100b will be described. Like elements to those shown and described herein will be identified with the same reference number, but with a “b” suffix, and the disclosure of such like elements is incorporated herein. The turret assembly 100b includes the turret 180b and a coupling assembly 190b that couples the turret 180b to one of the walls 140b of the housing assembly 110b. The coupling assembly 190b includes a plurality of the reinforcement supports 280b that both substantially circumferentially surround and contact the circumferential outer surface 200b of the turret 180b at locations other than the junction(s) 274b. Upper and central distal portion reinforcements 360, 365 are coupled to the plurality of reinforcement supports 280b of the distal portion 230b. Upper and central housing assembly arms 370, 375 are coupled to the housing assembly 110b. Upper and central turret arms 380, 385 couple the distal portion reinforcements 360, 365 to the housing assembly arms 370, 375. One or more bolts 270b couple the turret arms 380, 385 to the housing assembly arms 370, 375. One or more elbow portion reinforcements 330b are coupled to the reinforcement support(s) 280b of the elbow portion 220b. One or more lower housing assembly arms 390 are coupled to the housing assembly 110b. One or more lower turret arms 400 couple the elbow portion reinforcement(s) 330b to the lower housing assembly arm(s) 390 via bolt(s) 270b. One or more housing assembly plates 410, which are welded to the tank 110b, are coupled to the housing assembly 110b and the housing assembly arms 370, 375, 390.

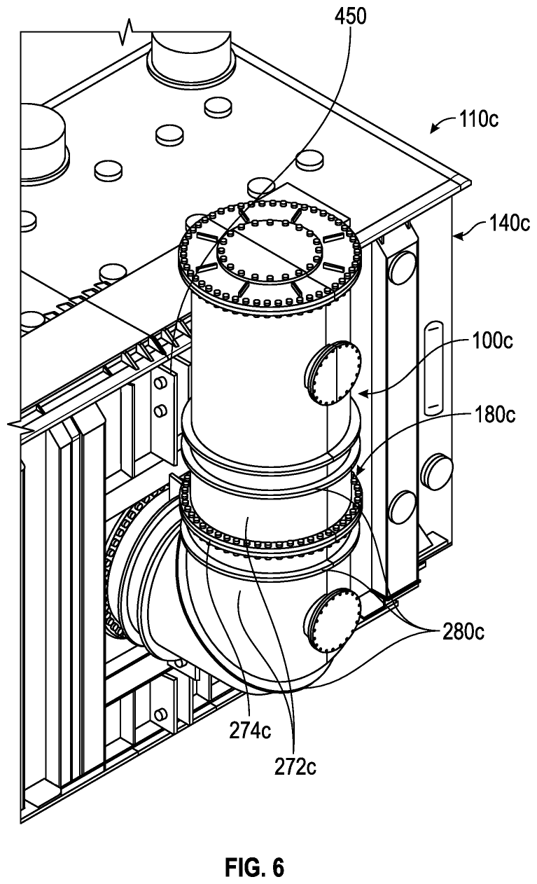

With reference to FIGS. 6-8, a further embodiment of a turret assembly 100c will be described. Like elements to those shown and described herein will be identified with the same reference number, but with a “c” suffix, and the disclosure of such like elements is incorporated herein. The turret assembly 100c includes the turret 180c and a coupling assembly 190c that couples the turret 180c to one of the walls 140c of the housing assembly 110c. The coupling assembly 190c includes a plurality of the reinforcement supports 280c that both substantially circumferentially surround and contact the circumferential outer surface 200c of the turret 180c at locations other than the junction(s) 274c. One or more distal portion connectors (e.g., plates) 440 are coupled to the reinforcement supports 280c of the distal portion 230c via welds. One or more housing assembly connectors (e.g., plates) 450 are coupled to the housing assembly 110c via welds. One or more upper turret connection arms 460 couple the distal portion connector(s) 440 to the housing assembly connector(s) 450 via pins 470 and keys 480. One or more elbow portion connectors 490 in the elbow portion 220c are coupled to the reinforcement supports 280c of the elbow portion 220c via welds. One or more lower turret connection arms 490 couple the elbow portion connector(s) 500 to the housing assembly connector(s) 450 via pins 470 and keys 480.

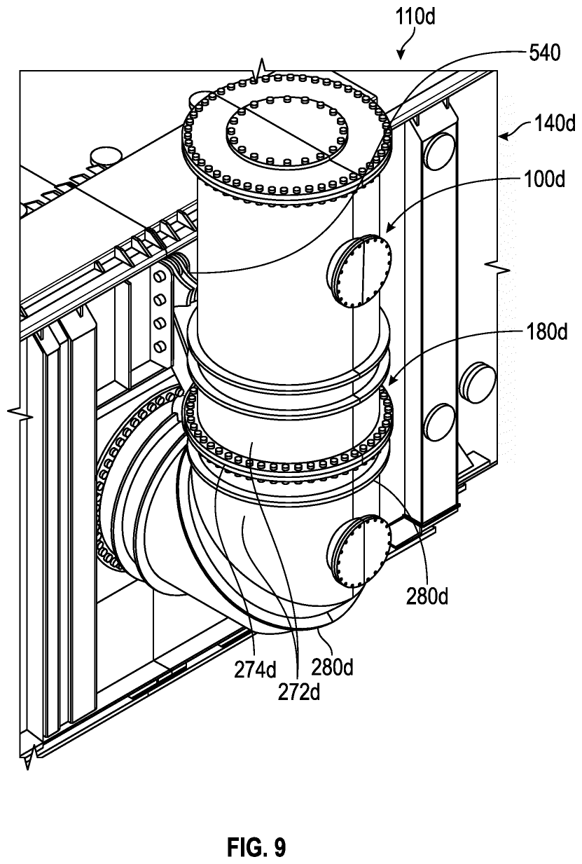

With reference to FIGS. 9-11, a still further embodiment of a turret assembly 100d will be described. Like elements to those shown and described herein will be identified with the same reference number, but with a “d” suffix, and the disclosure of such like elements is incorporated herein. The turret assembly 100d includes the turret 180d and a coupling assembly 190d that couples the turret 180d to one of the walls 140d of the housing assembly 110d. The coupling assembly 190d includes a plurality of the reinforcement supports 280d that both substantially circumferentially surround and contact the circumferential outer surface 200d of the turret 180d at locations other than the junction(s) 274d. One or more distal portion plates 530 are coupled to the plurality of reinforcement supports 280d of the distal portion 230d. One or more housing assembly plates 540 are coupled to the housing assembly 110d. One or more upper connection arms 550 couple the distal portion plate(s) 530 to the housing assembly plate(s) 540 via connection pins 560. One or more elbow portion plates 570 are coupled to the reinforcement supports 280d of the elbow portion 220d. One or more lower connection arms 590 couple the elbow portion plate(s) 570 to the housing assembly plate(s) 540 via connection pins 560. A turret inspection cover 600 is reinforced with thicker flanges 610 of at least 20 mm, and bigger bolts 620, sized at least M12. This reinforced inspection cover 600 is preferably included in all the embodiments of the turret assemblies 100, 100b, 100c, 100d, 100e, 100f shown and described herein.

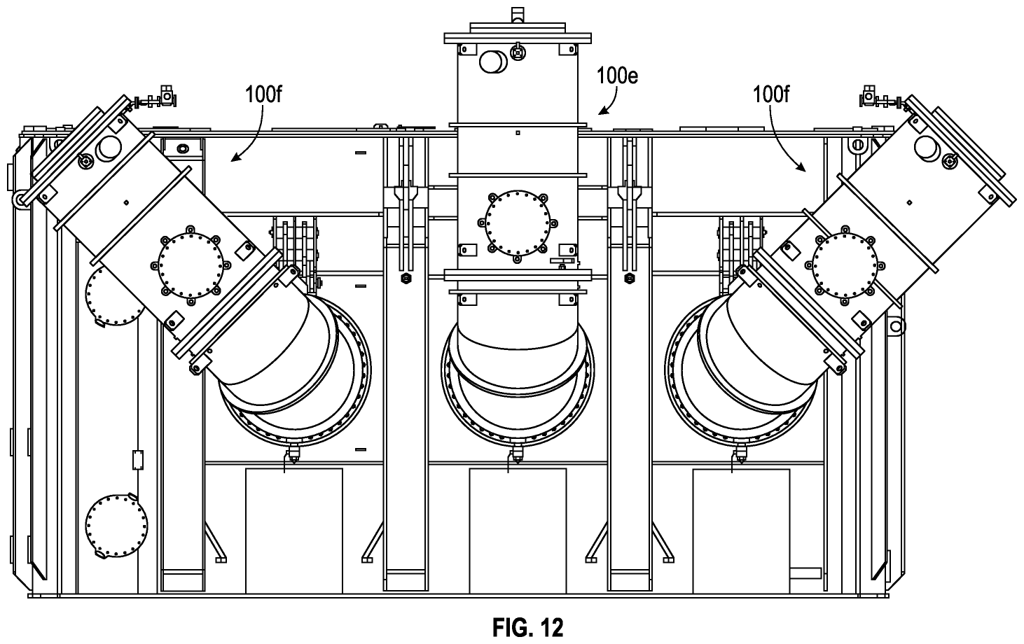

With reference to FIGS. 12-16, an embodiment of a vertical turret assembly 100e and an embodiment of inclined turret assemblies 100f coupled to an outer wall of a housing assembly of a transformer will be described.

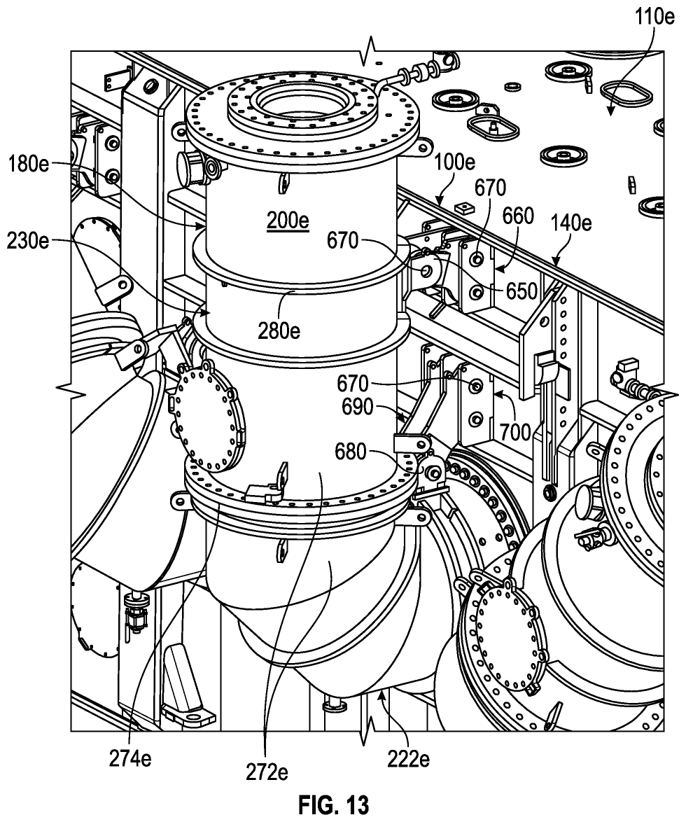

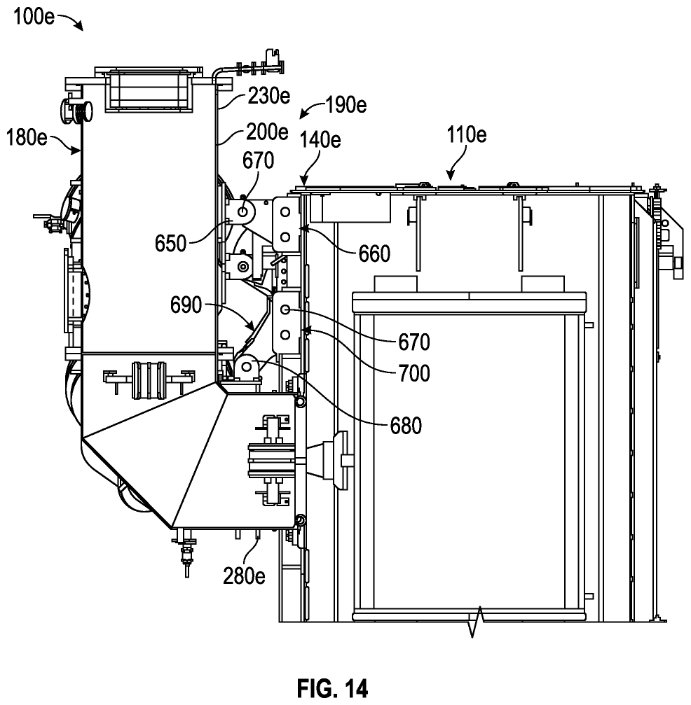

With reference to FIGS. 13 and 14, the embodiment of the vertical turret assembly 100e will first be described. Like elements to those shown and described herein will be identified with the same reference number, but with an “e” suffix, and the disclosure of such like elements is incorporated herein. The turret assembly 100e includes the turret 180e and a coupling assembly 190e that couples the turret 180e to one of the walls 140e of the housing assembly 110e. The coupling assembly 190e includes a plurality of the reinforcement supports 280e that both substantially circumferentially surround and contact the circumferential outer surface 200e of the turret 180e at locations other than the junction(s) 274e. One or more distal portion plates 650 are coupled to the plurality of reinforcement supports 280e of the distal portion 230e. One or more upper housing assembly plates 660 are coupled to the housing assembly 110e. One or more upper connection arms 670 couple the distal portion plate(s) 650 to the upper housing assembly plate(s) 660 via connection pins 670. One or more proximal plates 680 are coupled to the reinforcement supports 280e of the elbow horizontal portion 222e. One or more lower connection arms 690 couple the proximal plate(s) 680 to lower housing assembly plate(s) 700 via connection pins 670.

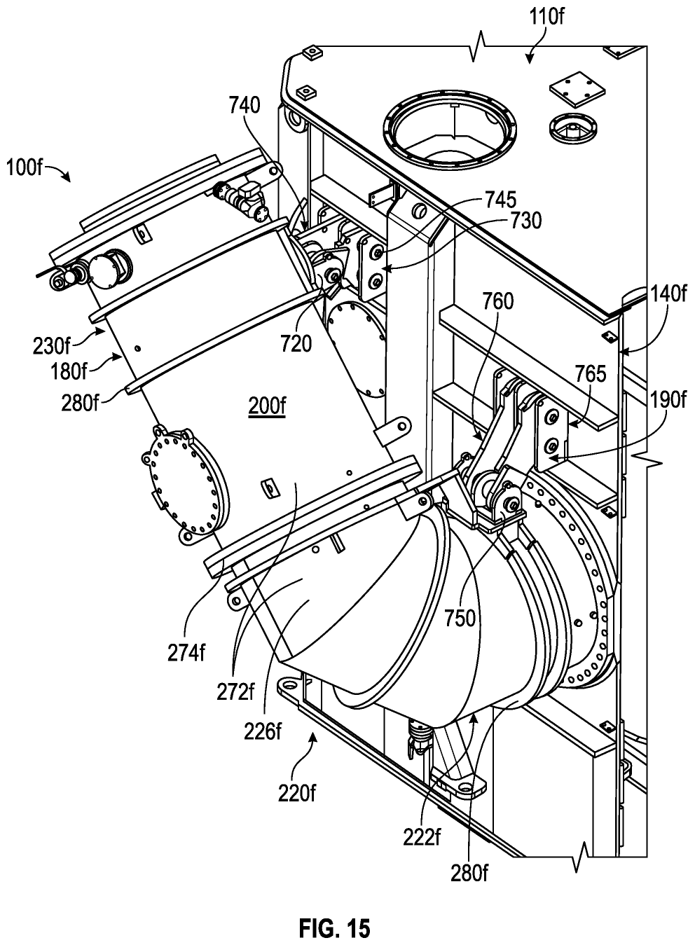

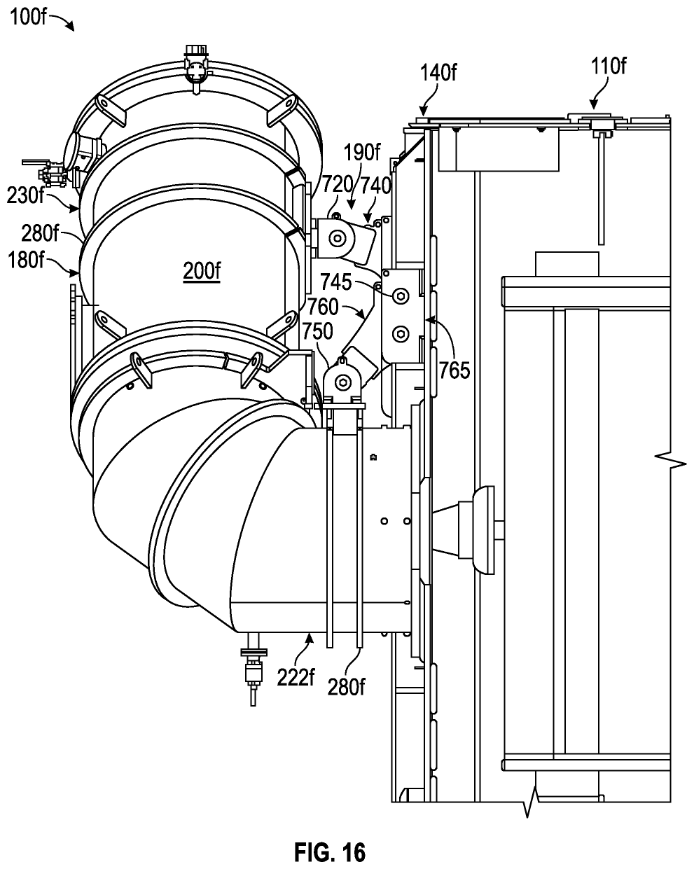

With reference to FIGS. 15 and 16, the embodiment of the inclined turret assembly 100f will now be described. Like elements to those shown and described herein will be identified with the same reference number, but with a “f” suffix, and the disclosure of such like elements is incorporated herein. The turret assembly 100f includes turret 180f inclined at an angle and a coupling assembly 190f that couples the inclined turret 180f to walls 140f of the housing assembly 110f. The coupling assembly 190f includes a plurality of the reinforcement supports 280f that both substantially circumferentially surround and contact the circumferential outer surface 200f of the inclined turret 180f at locations other than the junction(s) 274f. One or more distal portion plates 720 are coupled to the plurality of reinforcement supports 280f of the distal portion 230f. One or more upper housing assembly plates 730 are coupled to the housing assembly 110f at location(s) offset vertically relative to the elbow horizontal portion 222f of the turret 180f and the elbow portion 220f includes an elbow inclined portion 226f due to the inclined nature of the turret 180f. One or more upper connection arms 740 couple the distal portion plate(s) 720 to the upper housing assembly plate(s) 730 via connection pins 745. One or more proximal plates 750 are coupled to the reinforcement supports 280f of the elbow horizontal portion 222f. One or more lower connection arms 760 couple the proximal plate(s) 750 to lower housing assembly plate(s) 765 via connection pins 745.

The turret assemblies 100, 100a, 100b, 100c, 100d, 100e, 100f are designed to resist undesirable arc energy levels that could occur on a network. The mechanical resistance of the turret assemblies 100, 100a, 100b, 100c, 100d, 100e, 100f is increased by the aforementioned thicker shell, thicker flanges, bigger bolts size including higher tightening torque, reinforcement support (e.g., reinforcement ring) 280, 280a, 280b, 280c, 280d, 280e, 280f to couple the turret 180, 180a, 180b, 180c, 180d, 180e, 180f to wall 140, 140a, 140b, 140c, 140d, 140e, 140f and smoothly distribute the stress, and main tank wall reinforcement(s) (e.g., wall reinforcements 150, wall reinforcement gussets 160) to attach the turret 180, 180a, 180b, 180c, 180d, 180e, 180f. Once the pressure is contained by the turret assemblies 100, 100a, 100b, 100c, 100d, 100e, 100f the load will be transferred into the housing assembly 110, 110a, 110b, 110c, 110d, 110e, 110f which may deform and absorb this energy.

The above description of the various disclosed embodiments is provided to enable any person skilled in the art to make or use the various embodiments disclosed. Various modifications to these embodiments will be readily apparent to those skilled in the art, and the general principles described herein can be applied to other embodiments. Thus, it is to be understood that the description and drawings presented herein represent presently preferred embodiments, and therefore, are merely representative of the subject matter which is broadly contemplated. It is to be further understood that the scope of the present disclosure fully encompasses other embodiments that may become obvious to those skilled in the art and that the scope of the present disclosure is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

1.-22. (canceled)

23. A turret assembly, comprising:
a turret configured to contain pressure and including a circumferential outer surface, an elbow portion configured to couple to a housing assembly, and a distal portion extending distally from the elbow portion; and
a coupling assembly configured to further couple the turret to the housing assembly, the coupling assembly including a reinforcement support configured to substantially surround and contact the circumferential outer surface of the turret,
wherein the coupling assembly includes a plurality of reinforcement supports that both substantially circumferentially surround and contact the circumferential outer surface of the turret in the distal portion, and
a distal portion plate coupled to the plurality of reinforcement supports of the distal portion, a housing assembly plate configured to be coupled to the housing assembly, and a connection arm and a plurality of connection pins coupling the distal portion plate to the housing assembly plate.

24. The turret assembly of claim 23, wherein the turret includes a plurality of sections and a junction where the sections come together, and the coupling assembly includes a plurality of reinforcement supports configured to substantially circumferentially surround and contact the circumferential outer surface of the turret in at least one of the elbow portion and the distal portion at locations other than the junction.

25. The turret assembly of claim 23, wherein the elbow portion includes an elbow horizontal portion, an elbow angle portion, and an elbow vertical portion, and the coupling assembly includes a plurality of reinforcement supports configured to substantially circumferentially surround and contact the circumferential outer surface of the turret in the distal portion and at least one of the elbow horizontal portion, the elbow angle portion, and the elbow vertical portion.

26. The turret assembly of claim 23, wherein the turret includes at least one shell having a thickness greater than 8 mm.

27. The turret assembly of claim 23, wherein the coupling assembly includes at least one of reinforcement support(s), plate(s), connection plate(s), flange(s), reinforcement(s), arm(s), connection part(s), bolt(s), pin(s), weld(s), key(s), and keyway(s).

28. The turret assembly of claim 27, wherein at least one flange has a thickness greater than 30 mm.

29. The turret assembly of claim 27, wherein at least one bolt has a diameter greater than m20.

30. The turret assembly of claim 27, wherein at least one bolt is configured for a tightening torque application greater than 300 Nm.

31. The turret assembly of claim 23, further including an elbow portion plate coupled to the reinforcement support of the elbow portion, and a lower connection arm and a plurality of connection pins coupling the elbow portion plate to the housing assembly plate.

32. The turret assembly of claim 23, further including a housing assembly configured to house an electrical component, the housing assembly comprises a tank, and the electrical component comprises at least one of a transformer and a shunt reactor housed within the tank.

33. The turret assembly of claim 32, wherein the housing assembly comprises a tank and the tank includes at least one of a tank wall reinforcements and a tank wall reinforcement gussets in an area of the tank where the turret assembly is coupled to the at least one of the plurality of outer walls.

34. A turret assembly, comprising:
a turret configured to contain pressure and including a circumferential outer surface, an elbow portion configured to couple to a housing assembly, and a distal portion extending distally from the elbow portion; and
a coupling assembly configured to further couple the turret to the housing assembly, the coupling assembly including a reinforcement support configured to substantially surround and contact the circumferential outer surface of the turret.

35. The turret assembly of any of claim 34, wherein the coupling assembly includes a plurality of reinforcement supports that both substantially circumferentially surround and contact the circumferential outer surface of the turret in the distal portion, a distal portion plate coupled to the plurality of reinforcement supports of the distal portion, a housing assembly plate configured to be coupled to the housing assembly, and a connection plate coupling the distal portion plate to the housing assembly plate.

36. The turret assembly of claim 35, further including an elbow portion plate coupled to the reinforcement support of the elbow portion and the housing assembly plate via the connection plate.

37. The turret assembly of claim 35, further including an elbow reinforcement configured to structurally reinforce the elbow portion.

38. The turret assembly of claim 34, wherein the coupling assembly includes a plurality of reinforcement supports that both substantially circumferentially surround and contact the circumferential outer surface of the turret in the distal portion, a distal portion reinforcement coupled to the plurality of reinforcement supports of the distal portion, a housing assembly arm configured to be coupled to the housing assembly, and a turret arm coupling the distal portion reinforcement to the housing assembly arm.

39. The turret assembly of claim 38, further including at least one bolt coupling the turret arm to the housing assembly arm.

40. The turret assembly of claim 38, further including an elbow portion reinforcement coupled to the reinforcement support of the elbow portion, a lower housing assembly arm configured to be coupled to the housing assembly, and a lower turret arm coupling the elbow portion reinforcement to the lower housing assembly arm.

41. The turret assembly of claim 38, further including a housing assembly plate configured to be coupled to the housing assembly.

42. The turret assembly of claim 34, wherein the coupling assembly includes a plurality of reinforcement supports that both substantially circumferentially surround and contact the circumferential outer surface of the turret in the distal portion, a distal portion connector coupled to the plurality of reinforcement supports of the distal portion, a housing assembly connector configured to be coupled to the housing assembly, and a turret arm and a plurality of connection pins coupling the distal portion connector to the housing assembly connector.

43. The turret assembly of claim 42, further including an elbow portion connector coupled to the reinforcement support of the elbow portion, a housing connector configured to be coupled to the housing assembly, and a lower turret arm and a plurality of connection pins coupling the elbow portion connector to the housing assembly connector.

44. The turret assembly of claim 34, wherein the elbow portion includes an elbow horizontal portion, an elbow angle portion, and an elbow inclined portion, the turret is inclined at an angle, and the coupling assembly includes a plurality of reinforcement supports that both substantially circumferentially surround and contact the circumferential outer surface of the turret in the distal portion and in at least one of the elbow horizontal portion, the elbow angle portion, and the elbow inclined portion.
